(19) United States
(12) Patent Application Publication
(10) Pub. No.: US 2016/0365096 A1
(43) Pub. Date: Dec. 15, 2016

(54) TRAINING CLASSIFIERS USING SELECTED COHORT SAMPLE SUBSETS

(71) Applicant: INTEL CORPORATION, Santa Clara, CA (US)

(72) Inventors: Tobias Bocklet, Munich (DE); Adam Marek, Gdansk (PL)

(21) Appl. No.: 15/121,004

(22) PCT Filed: Mar. 28, 2014
(86) PCT No.: PCT/PL2014/050017

§ 371 Date: Aug. 23, 2016

(51) Int. Cl. G10L 17/04; G10L 17/16; G10L 17/08; G10L 17/02

(52) U.S. Cl. CPC G10L 17/04; G10L 17/02; G10L 17/16; G10L 17/08

(57) ABSTRACT

Various systems, apparatuses, and methods for training classifiers using selected cohort sample subsets are disclosed herein, in an example, a set of target supervectors, representing a target class, is received, and a set of cohort supervectors, representing a cohort class, is received. A distance metric is calculated from a respective cohort supervector to a respective target supervector, and a proper subset of cohort supervectors are selected based on the calculated distance metrics. The set of target supervectors and the selected proper subset of cohort supervectors are used to train a classifier. Further examples described herein describe how training classifiers using selected cohort sample subsets may be used to increase performance and decrease resource consumption in voice biometric systems.

### TECHNICAL FIELD

Embodiments described herein generally relate to training classifiers using selected cohort sample subsets, and in particular, to training speaker verification classifiers using selected cohort utterance subsets.

### BACKGROUND

Voice biometric systems attempt to verify the claimed identify of a speaker based on a voice sample (e.g., “utterance”) speaker. Some voice biometric systems utilize machine-learning algorithms, which are trained to distinguish between the target speaker's utterances and other speakers' utterances, known as “cohort/impostor utterances.” Increasing the number of cohort utterances may improve the accuracy of the machine-learning algorithm but may also increase the resources and time necessary for the machine-learning algorithm to model the cohort-speaker class and for the classifier to classify an utterance as belonging to either the target-speaker class or the cohort-speaker class, and may have a negative effect on performance.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 illustrates a system for training a classifier to authenticate a human speaker by using selected cohort speaker sample subsets, in accordance with some embodiments;

FIG. 2 illustrates a system for classifying a voice authentication attempt using a classifier trained using selected cohort speaker sample subsets, in accordance with some embodiments;

FIG. 3 illustrates a flowchart for a method for obtaining supervectors from analog audio input, in accordance with some embodiments;

FIG. 4 illustrates a flowchart for a method for training a classifier, using selected cohort sample subsets, to classify an observation, in accordance with some embodiments;

FIG. 5 illustrates a block diagram for software and electronic components used to train a classifier to authenticate a human speaker by using selected cohort speaker sample subsets, in accordance with some embodiments; and

FIG. 6 illustrates a block diagram for an example machine upon which any one or more of the techniques(e.g., operations, processes, methods, and methodologies) discussed herein may be performed, in accordance with some embodiments.

### DETAILED DESCRIPTION

The following description and the drawings illustrate specific embodiments to enable those skilled in the art to practice them. Other embodiments may incorporate structural, logical, electrical, process, and other changes. Portions and features of various embodiments may be included in, or substituted for, those of other embodiments. Embodiments set forth in the claims encompass all available equivalents of those claims.

Voice biometric systems, which attempt to verify the claimed identify of a speaker based on a voice sample (e.g., “utterance”) from the speaker, may be divided into text-dependent and text-independent categories. Text-dependent systems require the user to utter a specific keyword or key-phrase in order to verify the user's identity. Text-independent systems are designed to identify a user by the user's voice, independent of the word(s) or phrase(s) uttered. Text-dependent systems are more suitable for authentication/login scenarios (e.g., telephone banking), whereas text-independent systems are more suited for use in the fields of forensics and secret intelligence, (e.g., wire-tapping).

A classifier is a process that identifies to which of a set of categories (e.g., sub-populations)a new observation belongs, based on a training set of data containing observations (or instances) whose category membership is known. Classifiers, such as Support Vector Machines (SVMs) with or without channel compensation, have often been used in voice biometric systems. Typically, a statistical speaker model, such as a Gaussian Mixture Model (GMM), is created to model a speaker and a classifier is used to decide whether an utterance was spoken by the speaker. The non-speaker class (e.g., the cohort class is modeled by a huge set of cohort speakers, Such speaker-model classification systems suffer from at least two drawbacks:

1. Modeling the non-speaker class becomes more resource and time consuming as the number of cohort speakers increases,

2. Adding too many utterances to the non-speaker class may have a negative effect on the system's performance.

To overcome these drawbacks, a subset of utterance-specific, non-speaker samples from a set of cohort utterances may be selected and used to model the non-speaker class. A distance metric is calculated to determine the similarity between the cohort utterances and the enrollment/training utterances of a speaker. The “closest” cohort utterances, e.g., utterances with the smallest distance, are then used to model the non-speaker class when training the classifier. This results in amore flexible and cleaner modeling of the non-speaker class because the number of cohort utterances is significantly reduced, thereby improving recognition performance. This approach significantly reduces the computational complexity and memory consumption of the system and makes the system suitable to use on devices with memry and processor constraints, such as application-specific integrated circuits (ASICs).

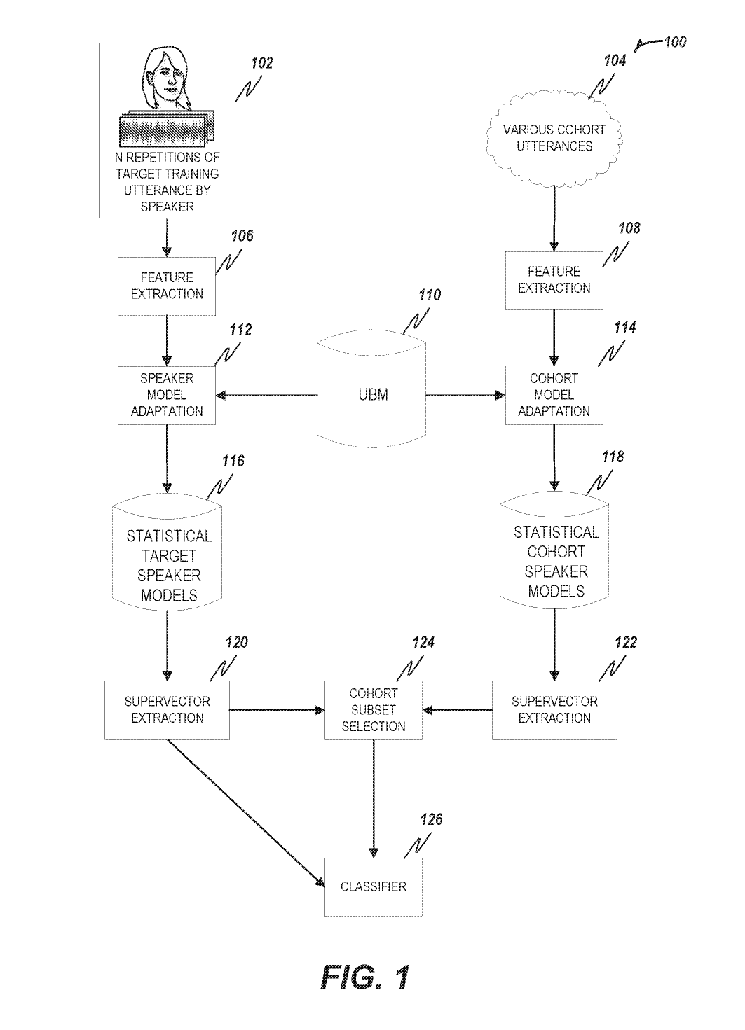

FIG. 1 illustrates a system 100 for training a classifier 126 to authenticate a human speaker by using selected cohort speaker sample subsets, in accordance with some embodiments, A target user may wish to enroll into a voice biometric system in order to access a logical and/or physical resource in a secure manner. For example, the target user may wish to enroll into a financial institution's voice biometric system in order to access financial data via telephone, System 100 may be used to enroll the user into such a voice biometric system.

In some embodiments, system 100 is contained within a single device, such as a smartphone, cellular telephone, mobile phone, laptop computer, tablet computer, desktop computer, server, computer station, computer kiosk, or an ASIC. In some embodiments, the components of system 100 are distributed amongst nuatiple devices, which may or may not be co-located.

System 100 includes n repetitions of a target training utterance 102 spoken by the target speaker. System 100 also includes various cohort utterances 104 spoken by a plurality of cohort speakers. In some embodiments, the n repetitions of a target training utterance 102 and/or the various cohort utterances 104 are received in near real-time by system 100 using an analog audio input component, such as a microphone. In some embodiments, the n repetitions of a target training utterance 102 and/or the various cohort utterances 104 are previously recorded audio, and are received or retrieved by system 100.

Features of speech are extracted 106 from each of the n repetitions of a target training utterance 102 spoken by the target speaker. Features of speech are also extracted 108 from the various cohort utterances 104 spoken by the plurality of cohort speakers. In some embodiments, the features of speech extracted may be provided from identified patters or features of audio, such as mel-frequency cepstral coefficients (MFCCs), perceptual linear prediction features (PLPs), Tempo-RA1 Patterns (TRAPS), or the like, or other features used in speech verification and/or speech recognition.

One or more speaker models 112, 114 are adapted to the extracted features 106, 108 to generate statistical target speaker models 116 and statistical cohort speaker models 118, respectively. A universal background model (UBM) is a model trained from numerous hours (e.g., tens or hundreds) of speech data gathered from a large number of speakers. A UBM represents a distribution of the feature vectors that is speaker-independent; thus, a UBM contains data representing general human speech. In some embodiments, during enrollment of a new (target or cohort) speaker into the system, some or all of the parameters of an optional UBM 110 may be adapted to the extracted features 106, 108 of the new speaker to generate the statistical speaker models 116, 118. In some embodiments, the adaptation function is maximum a posteriori (MAP), maximum likelihood linear regression (MLLR), or other adaptation functions currently known or unknown in speech verification/recognition arts.

In some embodiments, one statistical target speaker model 116 is created for each of the n repetitions of a target training utterance 102. In some embodiments, the adapted cohort speaker features are converted into statistical cohort speaker models 118. In some enibodiments, one statistical cohort speaker model is created for each of the various cohort utterances 104. In some embodiments, the statistical target speaker models 116 and/or the statistical cohort speaker models 118 are Gaussian Mixture Models (GMMs).

A supervector, which represents an utterance, is a combination of multiple smaller-dimensional vectors representing features of the utterance, the combination creating one higher-dimensional vector of fixed dimensions. Supervectors are extracted 120, 122 from the statistical target speaker models 116 and the statistical cohort speaker models 118, respectively. In some embodiments, n target speaker supervectors are extracted 120, corresponding to the n repetitions of a target training utterance 102 spoken by the target speaker. A cohort supervector is extracted 122 for each of the various cohort utterances 104 spoken by respective cohort speakers.

The n extracted target speaker supervectors 120 and the extracted cohort speaker supervectors 122 are used to select 124 a subset of the extracted cohort speaker supervectors 122. In some embodiments, a distance metric is calculated from each cohort speaker supervector to each target speaker supervector, the distance metric representing a similarity between the respective cohort speaker supervector and the respective target speaker supervector. bn some embodiments, the distance metric is one of a Mahalanobis, Bhattachaiyya, Euclidean, or City Block distance.

When using City Block distance to calculate the distance metric between supervectors a and h, the following equation may be used:

Σᵢ₌₀^{D-1|}aᵢ−bᵢ|

where D is the dimension of supervectors a and b.

For each target speaker supervector, the k-nearest cohort supervectors are selected. The value of k may vary, depending on the desired accuracy of the classifier 126. Then extracted target speaker supervectors 120 and the selected k*n cohort supervectors 124 are then provided to classifier 126, which uses the supervectors to train to recognize the target speaker's voice. In some embodiments, classifier 126 is a Support Vector Machine (SVM).

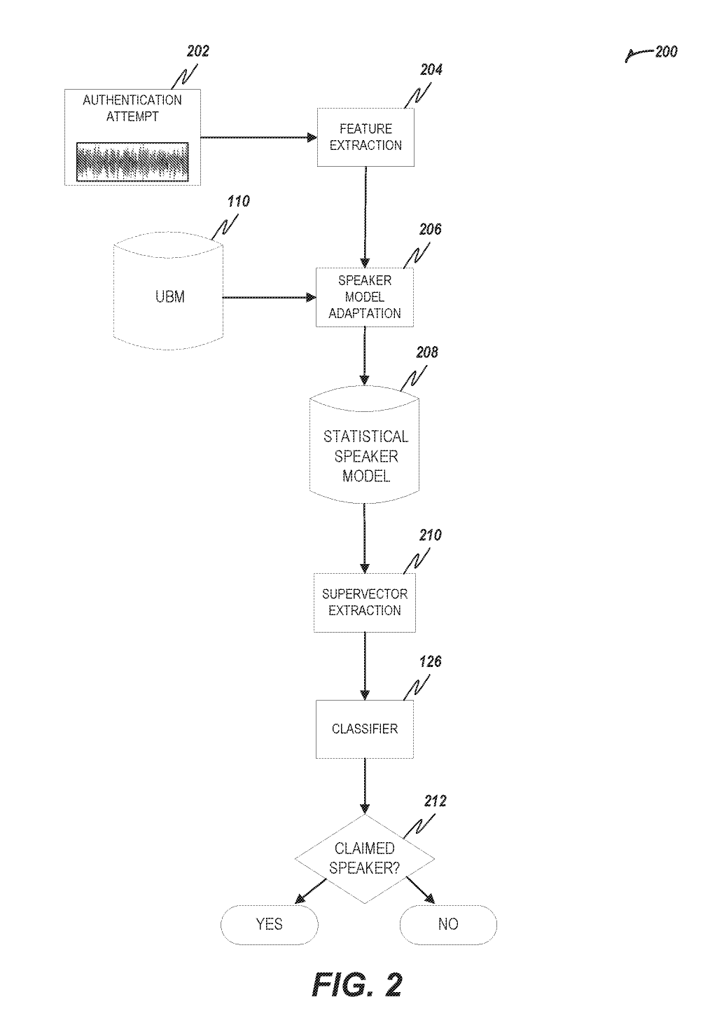

FIG. 2 illustrates a system 200 for classifying a voice authentication attempt 202 using a classifier 126 trained using selected cohort speaker sample subsets, in accordance with some embodiments. In some embodiments, the outcome of the classification of the voice authentication attempt 202 results in allowing or denying some action, such as allowing or denying access to protected information, or allowing or denying physical access to a protected area or device.

In some embodiments, system 200 is contained within a single device, such as a smartphone, cellular telephone, mobile phone, laptop computer, tablet computer, desktop computer, server, computer station, computer kiosk, or an ASIC. In some embodiments, the components of system 200 are distributed amongst multiple devices, which may or may not be co-located. In some embodiments, system 20C) may be the same device(s) as 100.

A user makes a voice authentication attempt 202. In some embodiments, the user attempts this voice authentication attempt 202 by uttering the same training utterance used to train the classifier 126. In some embodiments, the user attempts this voice authentication attempt 202 by uttering a different utterance from that which was used to train the classifier 126. In some embodiments, the authentication utterance is received in near real-time by system 200 using an analog audio input component, such as a microphone.

Features of the user's voice authentication attempt 202 are extracted 204. In some embodiments, the features extracted are MFCCs, PLP, TRAPS, or the like. In some embodiments, the features are extracted using the same process(es) as used in feature extraction 106 and/or 108.

At this point in the process, it is not yet known whether the user is the same as the target speaker. In some embodiments, a speaker model is adapted 206 to the extracted features 204 to generate a statistical speaker model 208 for the voice authentication attempt 202. In some embodiments, the speaker model is optionally UBM 110. In some embodiments, the extracted features 204 are adapted using MAP adaptation, MLLR adaptation, or other adaptation functions currently known or unknown in speech verification/recognition arts. In some embodiments, the statistical speaker model 208 is a GMM.

A supervector is then extracted 210 from the statistical speaker model 208. The extracted supervector is then provided to classifier 126, which decides 212 whether the voice authentication attempt 202 was spoken by the claimed speaker. In some embodiments, if the voice authentication attempt 202 was spoken by the claimed speaker, actions such as allowing the claimed speaker access to protected information or physical access to a protected area or device may be performed. In some embodiments, if the voice authentication attempt 202 was not spoken by the Claimed speaker, actions such as denying the speaker access to protected information or physical access to a protected area or device may be performed.

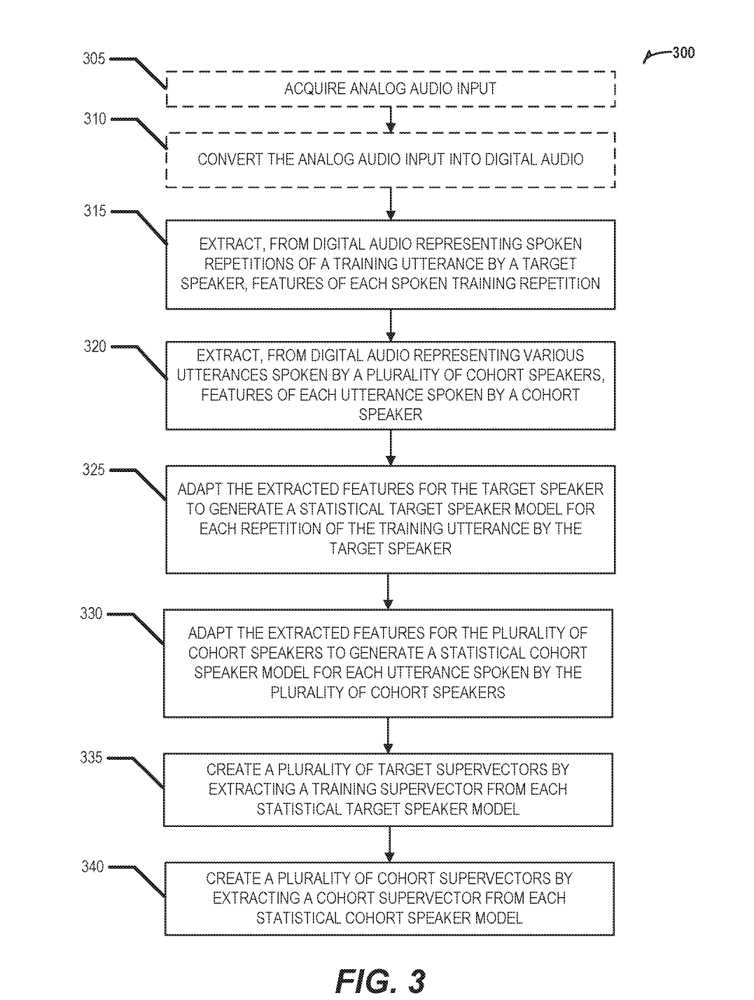

FIG. 3 illustrates a flowchart for a method 300 for obtaining supervectors from analog audio input, in accordance with some embodiments.

In some embodiments, analog audio input is optionally acquired (operation 305). In some embodiments, the analog audio input may be acquired using an analog audio input component, such as a microphone. In some embodiments, the analog audio input may be acquired from a stored audio recording. In some embodiments, the analog audio input includes repetitions of a training utterance spoken by a target user. In some embodiments, the analog audio input includes cohort utterances spoken by a plurality of cohort speakers.

In some embodiments, the optionally acquired analog audio input is converted into digital audio (operation 310). In some embodiments, an analog-to-digital converter converts the acquired analog audio input into digital audio.

Features of speech of each repetition of the training utterance spoken by the target user are extracted from the digital audio (operation 315). In some embodiments, these features may include MFCC, PLP, TRANS, or the like. The digital audio may have been converted from acquired analog audio input (operation 305), or the digital audio may have been received or retrieved from previously converted analog audio input.

Features of speech of the various utterances spoken by a cohort speaker are extracted from digital audio (operation 320). In some embodiments, these features may include MFCC, PLP, TRANS, or the like, The digital audio may have been converted from acquired analog audio input (operation 305), or the digital audio may have been received or retrieved from previously converted analog audio input.

A target speaker model is adapted to the extracted features for the target speaker to generate a statistical target speaker model for each repetition of the training utterance by the target speaker (operation 325), In sonie embodiments, the target speaker model is optionally a UBM (e.g., UBM 110).

A cohort speaker model is adapted the extracted features for the plurality of cohort speakers to generate a statistical cohort speaker model for each utterance spoken by the plurality of cohort speakers (operation 330). In some embodiments, the cohort speaker model is optionally UBM 110.

A plurality of target supervectors are created by extracting a target supervector from each statistical target speaker model (operation 335), and a plurality of cohort supervectors are created by extracting a cohort supervector from each statistical cohort speaker model (operation 340).

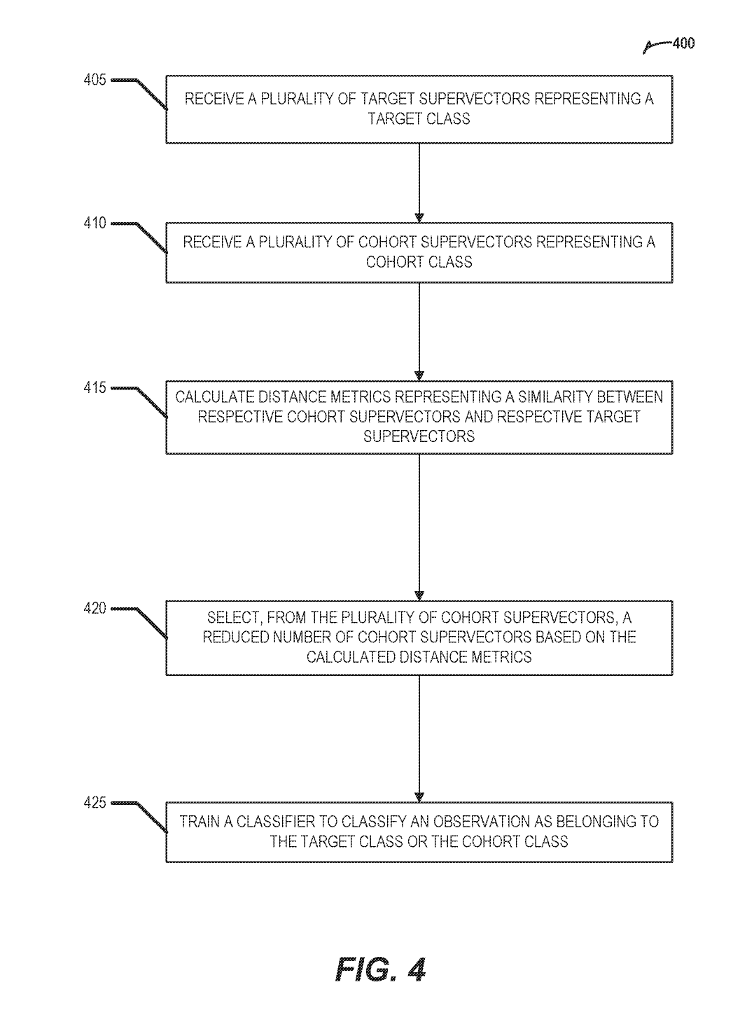

FIG. 4 illustrates a flowchart for a method 400 for training a classifier 126, using selected cohort sample subsets, to classify an observation, in accordance with some embodiments.

A plurality of target supervectors, representing a target class, is received or otherwise accessed (operation 405). In some apparatus embodiments, receiving may include reception of signals encoding the target supervectors. In some embodiments, accessing may include requesting a plurality of target supervectors from another component or another device.

A plurality of cohort supervectors, representing the cohort class, is received or otherwise accessed (operation 410). In some apparatus embodiments, receiving may include reception of signals encoding the cohort supervectors. In some embodiments, accessing may include requesting a plurality of cohort supervectors from another component or another device.

Distance metrics are calculated from respective cohort supervectors to respective target supervectors. The distance metrics may represent a similarity between the respective cohort supervectors and the respective target supervectors (operation 415).

Further processing is performed to reduce the number of cohort supervectors. For example, a proper subset of cohort supervectors may be selected, based on the calculated distance metrics, from the plurality of cohort supervectors (operation 420). A proper subset is a subset that is not the same as the original set itself.

Using the plurality of target supervectors and the proper subset of cohort supervectors, a classifier 126 is trained (operation 425) to classify an observation as belonging to the target class or the cohort class. In some embodiments, a trained classifier 126 is specific to the target speaker, to which the classifier 126 is trained.

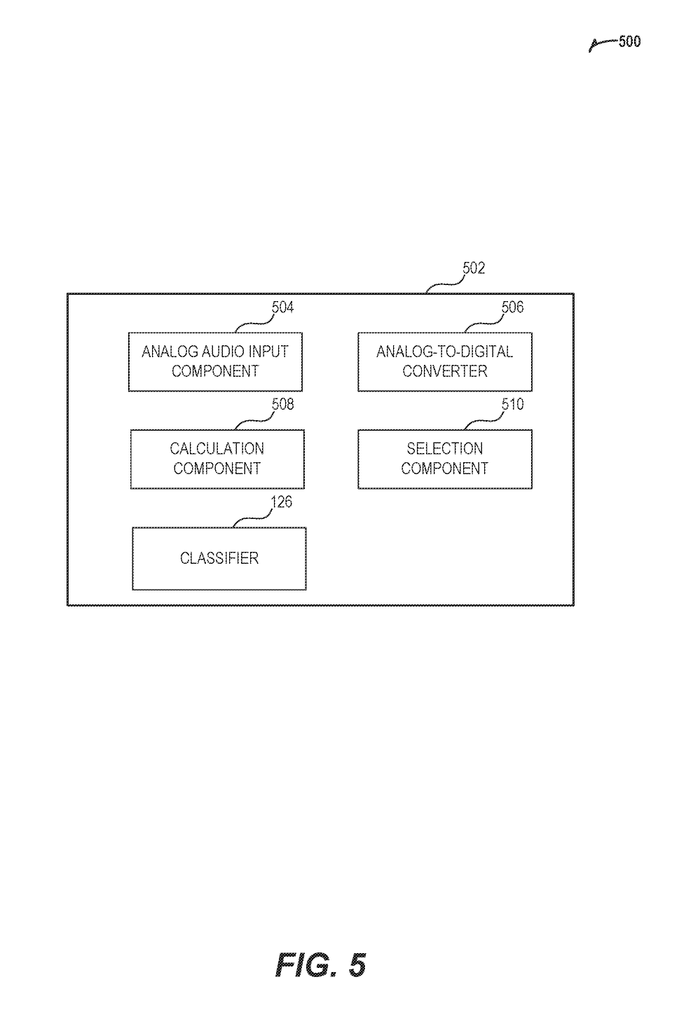

FIG. 5 illustrates a block diagram of software and electronic components 500 used to train a classifier 126 to authenticate a human speaker by using selected cohort speaker sample subsets, within a computer system (such computer system depicted as computing device 502), in accordance with some embodiments. Within the computing device 502, various software and hardware components are implemented in connection with a processor and memory (a processor and memory included in the computing device 502, for example) to train a classifier 126 to authenticate a human speaker by using selected cohort speaker sample subsets or to classify a voice authentication attempt as authentic.

In some embodiments, computing device 502 includes an analog audio input component 504, such as a microphone for acquiring audio input. This analog audio input component 504 may be integrated into a housing of the computing device 502, or it may be electrically coupled.

In some embodiments, computing device 502 includes an analog-to-digital converter 506 for converting acquired audio input into digital format.

In some embodiments, computing device 502 includes a calculation component 508 for calculating a distance metric from a respective cohort supervector to a respective target supervector. In some embodiments, the distance metric represents a similarity between the respective cohort supervector and the respective target supervector.

In some embodiments, computing device 502 includes a selection component 510 for selecting cohort speaker sample subsets of the cohort speaker supervectors. Selection component 510 selects the cohort sample subsets of the cohort supervectors based on the calculated distance metrics. In some embodiments, in selecting the cohort supervectors, the selection component 510 prefers cohort supervectors with smaller distance metrics to cohort supervectors larger distance metrics. That is, in a set of cohort supervectors with distances 2, 3, 5, 7, and 8, the supervector with distance 2 will be selected before the supervector with distance 3, which will be selected before the supervector with distance 5, etc.

In some embodiments, computing device 502 includes a classifier 126 that is trained using the target supervectors and the selected cohort speaker sample subsets to recognize the target speaker's voice.

In some embodiments, computing device 502 is a door lock, a gunlock, a bicycle lock, a vehicle ignition lock, a retail kiosk, a personal computer, a smartphone, a smart television, or combinations thereof.

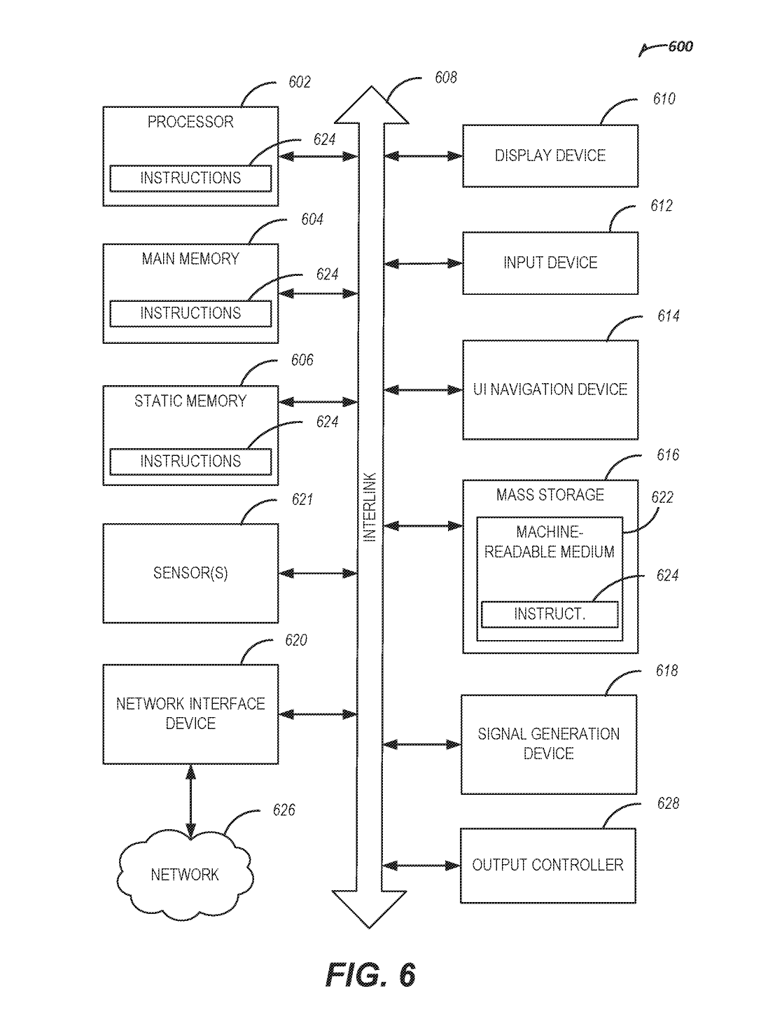

FIG. 6 illustrates a block diagram of an example machine 600 upon which any one or more of the techniques (e.g., methodologies) discussed herein may be executed, in accordance with some embodiments. Machine 600 may be embodied by the system 100, system 200, the system performing the operations of method 300, the system performing the operations of method 400, the computing device 502, or some combination thereof.

In alternative embodiments, the machine 600 may operate as a standalone device or may be connected (e.g., networked) to other machines. In a networked deployment, the machine 600 may operate in the capacity of a server machine, a client machine, or both in server-client network environments. In an example, the machine 600 may act as a peer machine in peer-to-peer (P2P) (or other distributed) network environment. The machine 600 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine 600 is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms. Modules are tangible entities (e.g., hardware) capable of performing specified operations and may be configured or arranged in a certain manner. In an example, circuits may be arranged internally or with respect to external entities such as other circuits in a specified manner as a module. In an example, the whole or part of one or more computer systems e.g., a standalone, client or server computer system) or one or more hardware processors may be configured by firmware or software (e.g., instructions, an application portion, or an application) as a module that operates to perform specified operations. In an example, the software may reside on a machine-readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

Machine (e.g., computer system) 600 may include a hardware processor 602 (e.g., a central processing unit (CPU), a graphics processing unit (GPU), a hardware processor core, or any combination thereof), a main memory 604 and a static memory 606, some or all of which may communicate with each other via an interlink (e.g., bus) 608. The machine 600 may further include a display unit 610, an alphanumeric input device 612 (e.g., a keyboard), and a user interface (UI) navigation device 614 (e.g., a mouse). In an example, the display unit 610, alphanumeric input device 612, and UI navigation device 614 may be a touch screen display. The machine 600 may additionally include a stoage device (e.g., drive unit) 616, a signal generation device 618 (e.g., a speaker), a network interface device 620, and one or more sensors 621, such as a global positioning system (GPS) sensor, compass, accelerometer, or other sensor. The machine 600 may include an output controller 628, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 616 may include a machine-readable medium 622 on which is stored one or more sets of data structures or instructions 624 (e.g., software embodying or utilized by any one or more of the techniques or functions described herein. The instructions 624 may also reside, completely or at least partially, within the main memory 604, within static memory 606, or within the hardware processor 602 during execution thereof by the machine 600, in an example, one or any combination of the hardware processor 602, the main memory 604, the static memory 606, or the storage device 616 may constitute machine-readable media.

Although the machine-readable medium 622 is illustrated as a single medium, the term “machine-readable medium” may include a single medium or multiple media(e.g., a centralized or distributed database, and/or associated caches and servers) configured to store the one or more instructions 624.

The term “machine-readable medium” may include any medium that is capable of storing, encoding, or carrying instructions 624 for execution by the machine 600 and that cause the machine 600 to perform any one or more of the techniques of the present disclosure, or that is capable of storing, encoding or currying data structures used by or associated with such instructions 624. Non-limiting machine-readable medium examples may include solid-state memories, and optical and magnetic media. In an example, amassed machine-readable medium comprises a machine-readable medium with a plurality of particles having resting mass. Specific examples of massed machine-readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 624 may further be transmitted or received over a communications network 626 using a transmission medium via the network interface device 620 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Tel (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, peer-to-peer (P2P) networks, among others. In an example, the network interface device 620 may include one or more physical jacks (e.g., Ethernet, coaxial, or phone jacks) or one or more antennas to connect to the communications network 626. In an example, the network interface device 620 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions 624 for execution by the machine 600, and includes digital or analog communications signals or other intangible medium to facilitate communication of such software.

The preceding systems, methods, devices, and examples were described in the context of classifying speech. In some embodiments, the preceding systems, methods, devices, and examples may also be used to classify images, videos, non-speech audio, or combinations thereof. For example, a classifier 126 may be trained to classify an image of a target human by providing the classifier 126 images of the target human and images of cohort humans. As another example, a classifier 126 may be trained to classify a video of a target human by providing the classifier 126 videos of the target human and videos of cohort humans,

Additional examples of the presently described method, system, and device embodiments include the following, non-limiting configurations. Each of the following non-limiting examples may stand on its own, or may be combined in any permutation or combination with any one or more of the other examples provided below or throughout the present disclosure.

Example 1 includes subject matter (embodied for example by a device, apparatus, machine, or machine-readable medium) of an apparatus to train, using a proper subset of cohort samples, a classifier to classify an observation, the apparatus comprising: a calculation component to calculate, from a respective cohort supervector to a respective target supervector, distance metric representing a similarity between the respective cohort supervector and the respective target supervector, the respective target supervector from a plurality of target supervectors representing a target class, the respective cohort supervector from a plurality of cohort supervectors representing a cohort class; a selection component to select, from the plurality of cohort supervectors, a proper subset of cohort supervectors based on the calculated distance metrics; and a training component to train a classifier to classify the observation as belonging to the target class or the cohort class, the training initiated by providing the plurality of target supervectors and the selected proper subset of cohort supervectors to the classifier.

In Example 2, the subject matter of Example 1 may optionally include a target supervector in the plurality of target supervectors representing an utterance spoken by a target speaker, and a supervector in the plurality of cohort supervectors representing an utterance spoken by a cohort speaker.

In Example 3, the subject matter of any one or more of Examples 1 to 2 may optionally include a target supervector in the plurality of target supervectors representing an image of a target human, and a cohort supervector in the plurality of cohort supervectors representing an image of a cohort human.

In Example 4, the subject matter of any one or more of Examples 1 to 3 may optionally include a target supervector in the plurality of target supervectors representing a video of a target human, and a cohort supervector in the plurality of cohort supervectors representing a video of a cohort human.

In Example 5, the subject matter of any one or more of Examples 1 to 4 may optionally include a target supervector in the plurality of target super vectors representing target audio, and a cohort supervector in the plurality of cohort supervectors representing cohort audio.

In Example 6, the subject matter of any one or more of Examples 1 to 5 may optionally include an analog audio input component to acquire analog audio input; and an analog-to-digital converter communicatively coupled to the analog audio input component to: receive the analog audio input from the analog audio input component; and convert the analog audio input into digital audio.

In Example 7, the subject matter of any one or more of Examples 1 to 6 may optionally include the apparatus being further to: extract, from digital audio representing spoken repetitions of a training utterance by a target speaker, features of a respective spoken training repetition; extract, from digital audio representing various utterances spoken by a plurality of cohort speakers, features of a respective utterance spoken by a cohort speaker; adapt the extracted features for the target speaker to generate a statistical target speaker model for a respective repetition of the training utterance by the target speaker; adapt the extracted features for the plurality of cohort speakers to generate a statistical cohort speaker model for a respective utterance spoken by the plurality of cohort speakers; create the plurality of target supervectors by extracting a target supervector from respective statistical target speaker models; and create the plurality of cohort supervectors by extracting a cohort supervector from respective statistical cohort speaker models.

In Example 8, the subject matter of any one or more of Examples 1 to 7 may optionally include the distance metric being one of: City Block, Mahalanobis, Bhattachaiya, or Euclidean.

In Example 9, the subject matter of any one or more of Examples 1 to 8 may optionally include the classifier being a support vector machine.

Example 10 includes, or may optionally be combined with all or portions of the subject matter of one or any combination of Examples 1-9, to embody subject matter (e.g., a method, machine-readable medium, or operations arranged or configured from an apparatus or machine) of instructions for training a classifier to classify an observation, the training using a proper subset of cohort samples, the instructions which when executed by a machine cause the machine to perform operations including: processing a plurality of target supervectors representing a target class; processing a plurality of cohort supervectors representing a cohort class; calculating, from a respective cohort supervector to a respective target supervector, a distance metric representing a similarity between the respective cohort supervector and the respective target supervector; selecting, from the plurality of cohort supervectors and based on the calculated distance metrics, a proper subset of cohort supervectors; and training the classifier to classify the observation as belonging to the target class or the cohort class, the training initiated by providing the plurality of target supervectors and the selected proper sA)set of cohort supervectors to the classifier.

In Example 11, the subject matter of Example 10 may optionally include each target supervector in the plurality of target supervectors representing an utterance spoken by a target speaker, and each cohort supervector in the plurality of cohort supervectors representing an utterance spoken by a cohort speaker.

In Example 12, the subject matter of any one or more of Examples 10 to 11 may optionally include each target supervector in the plurality of target supervectors representing an image of a target human, and each cohort supervector in the plurality of cohort supervectors representing an image of a cohort human.

In Example 13, the subject matter of any one or more of Examples 10 to 12 may optionally include each target supervector in the plurality of target supervectors representing a video of a target human, and each cohort supervector in the plurality of cohort supervectors representing a video of a cohort human.

In Example 14, the subject matter of any one or more of Examples 10 to 13 may optionally include each target supervector in the plurality of target supervectors representing target audio, and each cohort supervector in the plurality of cohort supervectors representing cohort audio.

In Example 15 the subject matter of any one or more of Examples 10 to 14 may optionally include further instructions, which when executed by the machine, cause the machine to perform operations including: acquiring analog audio input; and converting the analog audio input into digital audio.

In Example 16 the subject matter of any one or more of Examples 10 to 15 may optionally include further instructions, which when executed by the machine, cause the machine to perform operations including: extracting, from digital audio representing spoken repetitions of a training utterance by a target speaker, features of a respective spoken training repetition; extracting, from digital audio representing various utterances spoken by a plurality of cohort speakers, features of a respective utterance spoken by a cohort speaker; adapting the extracted features for the target speaker to generate a statistical target speaker model for a respective repetition of the training utterance by the target speaker; adapting the extracted features for the plurality of cohort speakers to generate a statistical cohort speaker model for a respective utterance spoken by the plurality of cohort speakers; creating the plurality of target supervectors by extracting a target supervector from respective statistical target speaker models; and creating the plurality of cohort supervectors by extracting a cohort supervector from respective statistical cohort speaker models.

In Example 17 the subject matter of any one or more of Examples 10 to 16 may optionally include the distance metric being one of: City Block, Mahalanobis, Bhattachaiya, or Euclidean.

Example 18 includes, or may optionally be combined with all or portions of the subject matter of one or any combination of Examples 1-17, to embody subject matter (e.g., a method, machine-readable medium, or operations arranged or configured from an apparatus or machine) for training a classifier to classify an observation, the training using a proper subset of cohort samples, the method comprising operations performed by a processor and memory of a computing system, the operations including: processing a plurality of target supervectors representing a target class; processing a plurality of cohort supervectors representing a cohort class; calculating, from a respective cohort supervector to a respective target supervector, a distance metric representing a similarity between the respective cohort supervector and the respective target supervector; selecting, from the plurality of cohort supervectors, a proper subset of cohort supervectors based on the calculated distance metrics; and training the classifier to classify the observation as belonging to the target class or the cohort class, the training initiated by providing the plurality of target super vectors and the selected proper subset of cohort supervectors to the classifier.

In Example 19, the subject matter of Example 18 may optionally include each target supervector in the plurality of target supervectors representing an utterance spoken by a target speaker, and each cohort supervector in the plurality of cohort supervectors representing an utterance spoken by a cohort speaker.

In Example 20, the subject matter of any one or more of Examples 18 to 19 may optionally include each target supervector in the plurality of target supervectors representing an image of a target human, and each cohort supervector in the plurality of cohort supervectors representing an image of a cohort human.

In Example 21, the subject matter of any one or more of Examples 18 to 20 may optionally include each target supervector in the plurality of tamet supervectors representing a video of a target human, and each cohort supervector in the plurality of cohort supervectors representing a video of a cohort human.

In Example 22, the subject matter of any one or more of Examples 18 to 21 may optionally include acquiring analog audio input; and converting the analog audio input into digital audio.

In Example 23, the subject matter of any one or more of Examples 18 to 22 may optionally include extracting, from digital audio representing spoken repetitions of a training utterance by a target speaker, features of a respective repetition of a training utterance by the target speaker; extracting, from digital audio representing various utterances spoken by a plurality of cohort speakers, features of a respective utterance spoken by a cohort speaker; adapting the extracted features for the target speaker to generate a statistical target speaker model for a respective repetition of the training utterance by the target speaker; adapting the extracted features for the plurality of cohort speakers to generate a statistical cohort speaker model for a respective utterance spoken by the plurality of cohort speakers; creating the plurality of target supervectors by extracting a target supervector from a respective statistical target speaker model; and creating the plurality of cohort supervectors by extracting a cohort supervector from a respective statistical cohort speaker model.

Example 24 includes subject matter for a machine-readable medium including instructions for operation of a computing system, which when executed by a machine, cause the machine to perform operations of any of the methods of Examples 18-23.

Example 25 includes subject matter for an apparatus comprising means for performing any of the methods of the subject matter of any one of Examples 18 to 23.

Example 26 includes, or may optionally be combined with all or portions of the subject matter of one or any combination of Examples 1-25, to embody subject matter (e.g., a device, apparatus, machine, or machine-readable medium) of an apparatus for training a classifier to classify an observation, the training using a proper subset of cohort samples, the apparatus comprising: means for processing a plurality of target supervectors representing a target class; means for processing a plurality of cohort supervectors representing a cohort class; means for calculating, from a respective cohort supervector to a respective target supervector, a distance metric representing a similarity between the respective cohort supervector and the respective target supervector; means for selecting, from the plurality of cohort supervectors, a proper subset of cohort supervectors based on the calculated distance metrics; and means for training the classifier to classify the observation as belonging to the target class or the cohort class, the training initiated by providing the plurality of target super vectors and the selected proper subset of cohort supervectors to the classifier.

In Example 27, the subject matter of Example 26 may optionally include each target supervector in the plurality of target supervectors representing an utterance spoken by a target speaker, and each cohort supervector in the plurality of cohort supervectors representing an utterance spoken by a cohort speaker.

In Example 28, the subject matter of any one or more of Examples 26 to 27 may optionally include each target supervector in the plurality of target supervectors representing an image of a target human, and each cohort super vector in the plurality of cohort supervectors representing an image of a cohort human.

In Example 29, the subject matter of any one or more of Examples 26 to 28 may optionally include each target supervector in the plurality of target supervectors representing a video of a target human, and each cohort supervector in the plurality of cohort supervectors representing a video of a cohort human.

In Example 30, the subject matter of any one or more of Examples 26 to 29 may optionally include each target supervector in the plurality of target super vectors representing target audio, and each cohort supervector in the plurality of cohort supervectors representing cohort audio.

In Example 31, the subject matter of any one or more of Examples 26 to 30 may optionally include means for acquiring analog audio input; and means for converting the analog audio input into digital audio.

In Example 32, the subject matter of any one or more of Examples 26 to 31 may optionally include means for extracting, from digital audio representing spoken repetitions of a training utterance by a target speaker, features of a respective repetition of a training utterance by the target speaker; means for extracting, from digital audio representing various utterances spoken by a plurality of cohort speakers, features of a respective utterance spoken by a cohort speaker; means for adapting the extracted features for the target speaker to generate a statistical target speaker model for a respective repetition of the training utterance by the tar speaker; means for adapting the extracted features for the plurality of cohort speakers to generate a statistical cohort speaker model for a respective utterance spoken by the plurality of cohort speakers; means for creating the plurality of target supervectors by extracting a target supervector from a respective statistical target speaker model; and means for creating the plurality of cohort supervectors by extracting a cohort supervector from a respective statistical cohort speaker model.

Example 33 includes, or may optionally be combined with all or portions of the subject matter of one or any combination of Examples 1-32, to embody subject matter (e.g., a method, machine-readable medium, or operations arranged or configured from an apparatus or machine) for enrolling a human user into a voice authentication system, the method comprising operations performed by a processor and memory of a computing system, the operations including: extracting met-frequency cepstral coefficients (MFCCs) representing features of each repetition of an enrollment utterance spoken by a target speaker; extracting MFCCs representing features of each enrollment utterance spoken by a plurality of cohort speakers; adapting, using maximum a posteriori (MAP) adaptation, a Universal Background Model (UBM) to the extracted MFCCs for the target speaker to generate a target speaker Gaussian Mixture Model (GMM) for each repetition of the enrollment utterance by the target speaker; adapting, using MAP adaptation, the UBM to the extracted MFCCs for the plurality of cohort speakers to generate a cohort speaker GMM for each enrollment utterance spoken by the plurality of cohort speakers; creating a plurality of enrollment supervectors by extracting an enrollment supervector from each target speaker GMM; creating a plurality of cohort supervectors by extracting a cohort supervector from each cohort speaker GMM; calculating, from each cohort supervector to each enrollment supervector, a city block distance metric representing a similarity between the cohort supervector and the enrollment supervector, wherein city block distance is the sum of the absolute differences of the projections of a line segment between the n Cartesian coordinates of each supervector; selecting, from the plurality of cohort supervectors, a proper subset of cohort supervectors based on the calculated distance metrics; and training a Support Vector Machine (SVM) to authenticate the target speaker, the training initiated by providing the plurality of enrollment supervectors and the selected proper subset of cohort supervectors to the SVM.

Example 34 includes subject matter e.g., a device, apparatus, or machine) of an apparatus for performing the operations of Example 33.

Example 35 includes subject matter (e.g., a method, machine-readable medium, or operations arranged or configured from an apparatus or machine) for enrolling a human user into a voice authentication system, the instructions which when executed by a machine cause the machine to perform the operations of Example 33.

Example 36 includes, or may optionally be combined with all or portions of the subject matter of one or any combination of Examples 1-35, to embody subject matter subject matter (e.g., a device, apparatus, machine, or machine-readable medium) of an apparatus to train, using a proper subset of cohort samples, a classifier to classify an observation, the apparatus comprising: means for extracting mel-frequency cepstral coefficients (MFCCs) representing features of each repetition of an enrollment utterance spoken by a target speaker; means for extracting MFCCs representing features of each enrollment utterance spoken by a plurality of cohort speakers; means for adapting, using maximum a posteriori (MAP) adaptation, a Universal Background Model (UBM) to the extracted MFCCs for the target speaker to generate a target speaker Gaussian Mixture Model (GMM) for each repetition of the enrollment utterance by the target speaker; means for adapting, using MAP adaptation, the UBM to the extracted MFCCs for the plurality of cohort speakers to generate a cohort speaker GMM for each enrollment utterance spoken by the plurality of cohort speakers; means for creating a plurality of enrollment supervectors by extracting an enrollment supervector from each target speaker GMM; means for creating a plurality of cohort supervectors by extracting a cohort supervector from each cohort speaker GMM; means for calculating, from each cohort supervector to each enrollment supervector, a city block distance metric representing a similarity between the cohort supervector and the enrollment supervector, wherein city block distance is the sum of the absolute differences of the projections of a line segment between the n Cartesian coordinates of each supervector; means for selecting, from the plurality of cohort supervectors, a proper subset of cohort supervectors based on the calculated distance metrics; and means for training a Support Vector Machine (SVM) to authenticate the target speaker, the training initiated by providing the plurality of enrollment supervectors and the selected proper subset of cohort supervectors to the SVM.

Example 37 includes, or may optionally be combined with all or portions of the subject matter of one or any combination of Examples 1-36, to embody subject matter subject matter (e.g., a device, apparatus, machine, or machine-readable medium) of an apparatus to train, using a proper subset of cohort samples, a classifier to classify an observation, the apparatus comprising: an analog audio input component to acquire analog audio input; an analog-to-digital converter communicatively coupled to the analog audio input component to: receive the analog audio input from the analog audio input component; and convert the analog audio input into digital audio; a calculation component to calculate, from a respective cohort supervector to a respective target supervector, a distance metric representing a similarity between the respective cohort supervector and the respective target supervector, the respective target supervector from a plurality of target supervectors representing a target class, the respective cohort supervector from a plurality of cohort supervectors representing a cohort class; a selection component to select, from the plurality of cohort supervectors, a proper subset of cohort supervectors based on the calculated distance metrics; and a training component to train a classifier to classify the observation as belonging to the target class or the cohort class, the training initiated by providing the plurality of target supervectors and the selected proper subset of cohort supervectors to the classifier.

In Example 38, the subject matter of Example 37 may optionally include the apparatus being further to: extract mel-frequency cepstral coefficients (MFCCs) representing features of each repetition of an enrollment utterance spoken by a target speaker; extract MFCCs representing features of each utterance spoken by a plurality of cohort speakers; adapt, using maximum a posteriori (MAP) adaptation, a Universal Background Model (UBM) to the extracted MFCCs for the target speaker to generate a target speaker Gaussian Mixture Model (GMM) for each repetition of the enrollment utterance by the target speaker; adapt, using MAP adaptation, the UBM to the extracted MFCCs for the plurality of cohort speakers to generate a cohort speaker GMM for each utterance spoken by the plurality of cohort speakers; create the plurality of enrollment supervectors by extracting an enrollment supervector from each target speaker GMM; and create the plurality of cohort supervectors by extracting a cohort supervector from each cohort speaker GMM.

In Example 39, the subject matter of any one or more of Examples 37 to 38 may optionally include the apparatus being a door lock.

In Example 40, the subject matter of any one or more of Examples 37 to 39 may optionally include the apparatus being a gunlock.

In Example 41, the subject matter of any one or more of Examples 37 to 40 may optionally include the apparatus being a bicycle lock.

In Example 42, the subject matter of any one or more of Examples 37 to 41 may optionally include the apparatus being a vehicle ignition lock.

In Example 43, the subject matter of any one or more of Examples 37 to 42 may optionally include the apparatus being a retail kiosk,

In Example 44, the subject matter of any one or more of Examples 37 to 43 may optionally include the apparatus being a personal computer.

In Example 45, the subject matter of any one or more of Examples 37 to 44 may optionally include the apparatus being a smartphone.

In Example 46, the subject matter of any one or more of Examples 37 to 45 may optionally include the apparatus being a smart television.

Example 47 includes, or may optionally be combined with all or portions of the subject matter of one or any combination of Examples 1-46, to embody subject matter subject matter (e.g., a method, machine-readable medium, or operations arranged or configured from an apparatus or machine) for training a classifier to classify an observation, the training using a proper subset of cohort samples, the method comprising operations perforrned by a processor and memory of a computing system, the operations including: receiving a plurality of target supervectors representing a target class; receiving a plurality of cohort supervectors representing a cohort class; calculating, from a respective cohort supervector to a respective target supervector, a distance metric representing a similarity between the respective cohort supervector and the respective target supervector, the respective target supervector from the plurality of target supervectors, the respective cohort supervector from the plurality of cohort supervectors, selecting, from the plurality of cohort supervectors, a proper subset of cohort supervectors based on the calculated distance metrics; and training the classifier to classitY the observation as belonging to the target class or the cohort class, the training initiated by providing the plurality of target supervectors and the selected proper subset of cohort supervectors to the classifier.

Example 48 includes subject matter (e.g., a method, machine-readable medium, or operations arranged or configured from an apparatus or machine) for enrolling a human user into a voice authentication system, the instructions which when executed by a machine cause the machine to perform the operations of Example 47.

Example 49 includes subject matter e.g., a device, apparatus, or machine) of an apparatus for performing the operations of Example 47.

Example 50 includes, or may optionally be combined with all or portions of the subject matter of one or any combination of Examples 1-49, to embody subject matter subject matter (e.g., a device, apparatus, machine, or machine-readable medium) of an apparatus to train, using a proper subset of cohort samples, a classifier to classiy an observation, the training using a proper subset of cohort samples, the apparatus comprising: means for receiving a plurality of target supervectors representing a target class; means for receiving a plurality of cohort supervectors representing a cohort class; means for calculating, from a respective cohort supervector to a respective target supervector, a distance metric representing a similarity between the respective cohort supervector and the respective target supervector, the respective target supervector from the plurality of target supervectors, the respective cohort supervector from the plurality of cohort supervectors; means for selecting, from the plurality of cohort supervectors, a proper subset of cohort supervectors based on the calculated distance metrics; and means for training the classifier to classify the observation as belonging to the target class or the cohort class, the training initiated by providing the plurality of target supervectors and the selected proper sUbset of cohort supervectors to the classifier.

Example 51 includes, or may optionally be combined with all or portions of the subject matter of one or any combination of Examples 1-50, to embody subject matter subject matter (e.g., a device, apparatus, machine, or machine-readable medium) of an apparatus to train, using a proper subset of cohort samples, a statistical classifier to classify an observation, the apparatus comprising: a first reception component to receive a plurality of tar supervectors representing a target class; a second reception component to receive a plurality of cohort supervectors representing a cohort class; a calculation component to calculate, from a respective cohort supervector to a respective target supervector, a distance metric representing a similarity between the respective cohort supervector and the respective target supervector, the respective target supervector from the plurality of target supervectors, the respective cohort supervector from the plurality of cohort supervectors; a selection component to select, from the plurality of cohort supervectors, a proper subset of cohort supervectors based on the calculated distance metrics; and a training component to train a statistical classifier to classify the observation as belonging to the target class or the cohort class, the training initiated by providing the plurality of target supervectors and the selected proper subset of cohort supervectors to the statistical classifier.

In Example 52, the subject matter of Example 51 may optionally include the second reception component being the first reception component.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplate are examples using any combination or permutation of those elements shown or described (or one or more aspects thereof), either with respect to a particular example (or one or more aspects thereof), or with respect to other examples or one or more aspects thereof) shown or described herein.

In this document, the terms “a” or “an” are used, as is common in patent documents, to include one or more than one, independent of any other instances or usages of “at least one” or “one or more,” In this document, the term “or” is used to refer to a nonexclusive or, such that “A or B” includes “A but not B,” “B but not A,” and “A and B:” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to suggest a numerical order for their objects.

The above description is intended to be illustrative, and not restrictive. For example, the above-described examples (or one or more aspects thereof) may be used in combination with others. Other embodiments may be used, such as by one of ordinary skill in the art upon reviewing the above description. Also, in the above Detailed Description, various features may be grouped together to streamline the disclosure. However, the claims may not set forth every feature disclosed herein and embodiments may feature a subset of said features. Further, embodiments may include fewer features than those disclosed in a particular example. Thus, the following Claims are hereby incorporated into the Detailed Description, with a claim standing on its own as a separate embodiment. The scope of the embodiments disclosed herein is to be determined with reference to the appended claims, along with the full scope of equivalents to which such claims are entitled.

1.-25. (canceled)

26. An apparatus to train, using a proper subset of cohort samples, a classifier to classify an observation, the apparatus comprising:
a calculation component to calculate, from a respective cohort supervector to a respective target supervector, a distance metric representing a similarity between the respective cohort supervector and the respective target supervector, the respective target supervector from a plurality of target supervectors representing a target class, the respective cohort supmector from a plurality of cohort supervectors representing a cohort class;
a selection component to select, from the plurality of cohort supervectors, a proper subset of cohort supervectors based on the calculated distance metrics; and
a training component to train a classifier to classify the observation as belonging to the target class or the cohort class, the training initiated by providing the plurality of target supervectors and the selected proper subset of cohort supervectors to the classifier.

27. The apparatus of claim 26, wherein a target supervector in the plurality of target supervectors represents an utterance spoken by a target speaker, and wherein a supervector in the plurality of cohort supervectors represents an utterance spoken by a cohort speaker.

28. The apparatus of claim 26, wherein a target supervector in the plurality of target supervectors represents an image of a target human, and wherein a cohort supervector in the plurality of cohort supervectors represents an image of a cohort human.

29. The apparatus of claim 26, wherein a target supervector in the plurality of target supervectors represents a video of a target human, and wherein a cohort supervector in the plurality of cohort supervectors represents a video of a cohort human.

30. The apparatus of claim 26, wherein a target supervector in the plurality of target supervectors represents target audio, and wherein a cohort supervector in the plurality of cohort supervectors represents cohort audio.

31. The apparatus of claim 26, further comprising:
an analog audio input component to acquire analog audio input; and
an analog-to-digital converter communicatively coupled to the analog audio input component to:
receive the analog audio input from the analog audio input component; and
convert the analog audio input into digital audio.

32. The apparatus of claim 31, wherein the apparatus is further to:
extract, from digital audio representing spoken repetitions of a training utterance by a target speaker, features of a respective spoken training repetition;
extract, from digital audio representing various utterances spoken by a plurality of cohort speakers, features of a respective utterance spoken by a cohort speaker;
adapt the extracted features for the target speaker to generate a statistical target speaker model for a respective repetition of the training utterance by the target speaker;
adapt the extracted features for the plurality of cohort speakers to generate a statistical cohort speaker model for a respective utterance spoken by the plurality of cohort speakers;
create the plurality of target supervectors by extracting a target supervector from respective statistical target speaker models; and
create the plurality of cohort supervectors by extractinga cohort supervector from respective statistical cohort speaker models.

33. The apparatus of claim 26, wherein the distance metric is one of: City Block, Mahalanobis, Bhattacharya, or Euclidean.

34. The apparatus of claim 26, wherein the classifier is a support vector machine.

35. A machine-readable medium including instructions for training a classifier to classify an observation, the training using a proper subset of cohort samples, the instructions which when executed by a machine cause the machine to perform operations including:
processing a plurality of target supervectors representing a target class,
processing a plurality of cohort supervectors representing a cohort class;
calculating, from a respective cohort supervector to a respective target supervector, a distance metric representing a similarity between the respective cohort supervector and the respective target supervector;
selecting, from the plurality of cohort supervectors and based on the calculated distance metrics, a proper subset of cohort supervectors; and
training the classifier to classify the observation as belonging to the target -lass or the cohort class, the training initiated by providing the plurality of target supervectors and the selected proper subset of cohort supervectors to the classifier.

36. The machine-readable medium of claim 35, wherein each target supervector in the plurality of target supervectors represents an utterance spoken by a target speaker, and wherein each cohort supervector in the plurality of cohort supervectors represents an utterance spoken by a cohort speaker.

37. The machine-readable medium of claim 35, wherein each target supervector in the plurality of target supervectors represents an image of a target human, and wherein each cohort supervector in the plurality of cohort supervectors represents an image of a cohort human.

38. The machine-readable medium of claim 35, wherein each target supervector in the plurality of target supervectors represents a video of a target human, and wherein each cohort supervector in the plurality of cohort supervectors represents a video of a cohort human.

39. The machine-readable medium of claim 35, wherein each target supervector in the plurality of target supervectors represents target audio, and wherein each cohort supervector in the plurality of cohort supervectors represents cohort audio.

40. The machine-readable medium of claim 35, further comprising instructions, which when executed by the machine, cause the machine to perform operations including:
acquiring analog audio input; and
converting the analog audio input into digital audio.

41. The machine-readable medium of claim 40, further comprising instructions, which when executed by the machine, cause the machine to perform operations including:
extracting, from digital audio representing spoken repetitions of a training utterance by a target speaker, features of a respective spoken training repetition;
extracting, from digital audio representing various utterances spoken by a plurality of cohort speakers, features of a respective utterance spoken by a cohort speaker;
adapting the extracted features for the target speaker to generate a statistical target speaker model for a respective repetition of the training utterance by the target speaker;
adapting the extracted features for the plurality of cohort speakers to generate a statistical cohort speaker model for a respective utterance spoken by the plurality of cohort speakers;
creating the plurality of target supervectors by extracting a target supervector from respective statistical target speaker models; and
creating the plurality of cohort supervectors by extracting a cohort supervector from respective statistical cohort speaker models.

42. The machine-readable medium of claim 35, wherein the distance metric is one of: City Block, Mahalanobis, Bhattacharya, or Euclidean.

43. A method for training a classifier to classify an observation, the training using a proper subset of cohort samples, the method comprising operations performed by a processor and memory of a computing system, the operations including:
processing a plurality of target supervectors representing a target class;
processing a plurality of cohort supervectors representing a cohort class;
calculating, from a respective cohort supervector to a respective taraet supervector, a distance metric representing a similarity between the respective cohort supervector and the respective target supervector;
selecting, from the plurality of cohort supervectors, a proper subset of cohort supervectors based on the calculated distance metrics; and
training the classifier to classify the observation as belonging to the target class or the cohort class, the training initiated by providing the plurality of target supeiNectors and the selected proper subset of cohort supervectors to the classifier.

44. The method of claim 43, wherein each target supervector in the plurality of target supervectors represents an utterance spoken by a target speaker, and wherein each cohort supervector in the plurality of cohort supervectors represents an utterance spoken by a cohort speaker.

45. The method of claim 43, wherein each target supervector in the plurality of target supervectors represents an image of a target human, and wherein each cohort supervector in the plurality of cohort supervectors represents an image of a cohort human.

46. The method of claim 43, wherein each target supervector in the plurality of target supervectors represents a video of a target human, and wherein each cohort supervector in the plurality of cohort supervectors represents a video of a cohort human.

47. The method of claim 43, further comprising:
acquiring analog audio input; and
converting the analog audio input into digita audio.

48. The method of claim 47, further comprising:
extracting, from digital audio representing spoken repetitions of a training utterance by a target speaker, features of a respective repetition of a training utterance by the target speaker;
extracting, from digital audio representing various utterances spoken by a plurality of cohort speakers, features of a respective utterance spoken by a cohort speaker;
adapting the extracted features for the target speaker to generate a statistical target speaker model for a respective repetition of the training utterance by the target speaker;
adapting the extracted features for the plurality of cohort speakers to generate a statistical cohort speaker model for a respective utterance spoken by the plurality of cohort speakers;
creating the plurality of target supervectors by extracting a target supervector from a respective statistical target speaker model; and
creating the plurality of cohort supervectors by extracting a cohort supervector from a respective statistical cohort speaker model.

49. The method of claim 43, wherein the distance metric is one of: City Block, Mahalanobis, Bhattacharya, or Euclidean.

50. The method of claim 43, wherein the classifier is a support vector machine.
